(19) United States
(12) Patent Application Publication
(10) Pub. No.: US 2018/0032686 A1
(43) Pub. Date: Feb. 1, 2018

(54) CONCEPTS FOR GENERATING AND MANAGING CARE TEAMS

(71) Applicant: CARADIGM USA LLC, Bellevue, WA (US)

(72) Inventors: Arpita Patadia, Bellevue, WA (US); Pradeep Shankar, Redmond, WA (US); Joybroto Banerjee, Bellevue, WA (US); Cynthia Sowder, Seattle, WA (US); Bhaskar Shankar Reddy, Bellevue, WA (US); Sumeet Shrivastava, Redmond, WA (US); Linda Walmer, Seattle, WA (US); Shawna Cooper, Redmond, WA (US); Venkatachari Sampathkumar, Santa Clara, CA (US)

(21) Appl. No.: 15/588,544

(22) Filed: May 5, 2017

Related U.S. Application Data
(63) Continuation of application No. 15/276,658, filed on Sep. 26, 2016, now abandoned.
Application No. 15/276,658 is a continuation of application No. 14/185,543, filed on Feb. 20, 2014, now abandoned.

(51) Int. Cl. G06F 19/00

(52) U.S. Cl. CPC G06F 19/327

(57) ABSTRACT

Computer program products, methods, systems, apparatus, and computing entities are provided for managing a care team. For example, in one embodiment, care team members can be added to a care team using a manual approach, a semi-automated approach, or an automated approach. The care team can then be displayed simultaneously in a single view with the relevant relationships, roles, and responsibilities.

### BACKGROUND

Creating and managing a patient's care team is an intricate proposition. A care team may include various personal and professional relationships, some of which are unique to the patient (e.g., spouse, sibling), others which come from directories of professionals (e.g., physicians), others which are professional organizations and services (e.g., DME providers), and still others which are community organizations (e.g., meal preparation). Having a single view of all these relationships is helpful to care managers who guide patients and focus on providing and encouraging coordinated care.

### BRIEF SUMMARY

In general, embodiments of the present invention provide methods, apparatus, systems, computing devices, computing entities, and/or the like for managing a care team.

In accordance with one aspect, a method for managing a care team is provided. In one embodiment, the method comprises (a) storing a plurality of care team member profiles in association with information for a patient, each care team member profile identifying the respective care team member's (i) role for and (ii) relationship with the patient; and (b) causing simultaneous display of at least a portion of each of the plurality of care team member profiles.

In accordance with another aspect, a computer program product for managing a care team is provided. The computer program product may comprise at least one computer-readable storage medium having computer-readable program code portions stored therein, the computer-readable program code portions comprising executable portions configured to (a) store a plurality of care team member profiles in association with patient information for a patient, each care team member profile identifying the respective care team member's (i) role for and (ii) relationship with the patient; and (b) cause simultaneous display of at least a portion of each of the plurality of care team member profiles.

In accordance with yet another aspect, an apparatus comprising at least one processor and at least one memory including computer program code is provided. In one embodiment, at least one memory and the computer program code may be configured to, with the processor, cause the apparatus to (a) store a plurality of care team member profiles in association with patient information for a patient, each care team member profile identifying the respective care team member's (i) role for and (ii) relationship with the patient; and (b) cause simultaneous display of at least a portion of each of the plurality of care team member profiles.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a management computing entity according to one embodiment of the present invention.

FIG. 3 is an exemplary schematic diagram of a care team member computing entity according to one embodiment of the present invention.

FIG. 4 is a flowchart illustrating operations and processes that can be used in accordance with various embodiments of the present invention.

FIGS. 5-20 are exemplary input and output that can be produced from various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

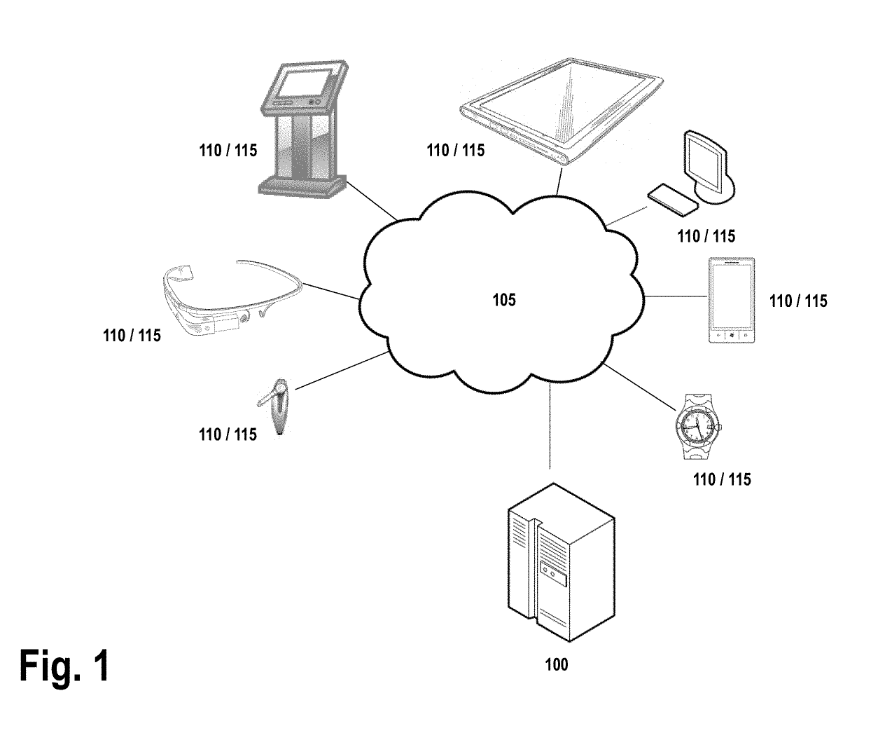

FIG. 1 provides an illustration of an exemplary embodiment of the present invention. As shown in FIG. 1, this particular embodiment may include one or more management computing entities 100, one or more networks 105, one or more care team member computing entities 110, and one or more patient computing entities 115. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Management Computing Entity

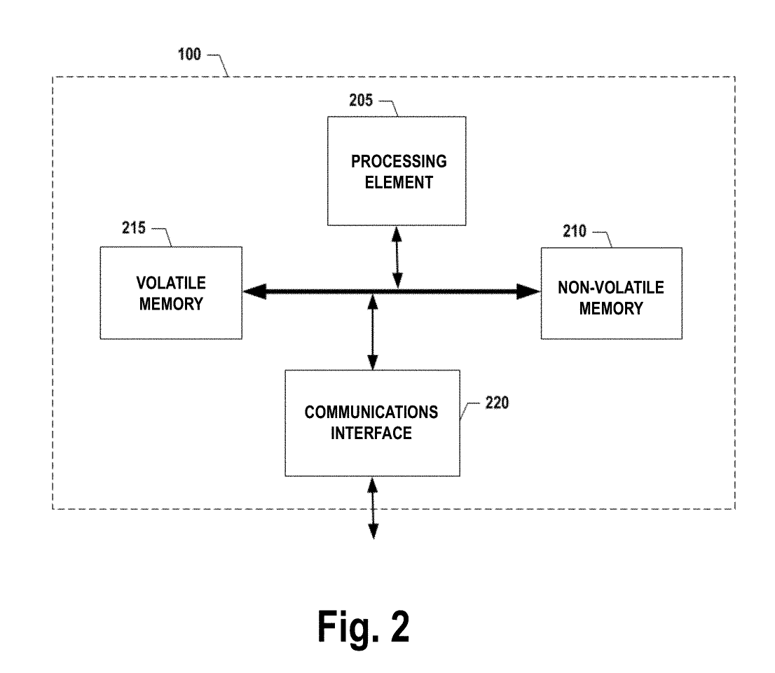

FIG. 2 provides a schematic of a management computing entity 100 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the management computing entity 100 may communicate with care team member computing entities 110 and provide functionalities of a care management platform.

As shown in FIG. 2, in one embodiment, the management computing entity 100 may include or be in communication with one or more processing elements 205 (also referred to as processors, processing circuitry, and/or similar terms used herein interchangeably) that communicate with other elements within the management computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management computing entities, data, applications, programs, program modules, scripts, source code, object code, byte code, compiled code, interpreted code, machine code, executable instructions, and/or the like. Such code may include a care management platform. The terms database, database instance, database management computing entity, and/or similar terms used herein interchangeably may refer to a structured collection of records or data that is stored in a computer-readable storage medium, such as via a relational database, hierarchical database, and/or network database.

In one embodiment, the management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management computing entities, data, applications, programs, program modules, scripts, source code, object code, byte code, compiled code, interpreted code, machine code, executable instructions, and/or the like being executed by, for example, the processing element 205. Thus, the databases, database instances, database management computing entities, data, applications, programs, program modules, scripts, source code, object code, byte code, compiled code, interpreted code, machine code, executable instructions, and/or the like may be used to control certain aspects of the operation of the management computing entity 100 with the assistance of the processing element 205 and operating system, such as the of care management platform.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like.

Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, near field communication (NFC) protocols, Bluetooth™ protocols, wireless universal serial bus (USB) protocols, and/or any other wireless protocol.

Although not shown, the management computing entity 100 may include or be in communication with one or more input elements, such as a keyboard input, a mouse input, a touch screen/display input, motion input, movement input, audio input, pointing device input, joystick input, keypad input, and/or the like. The management computing entity 100 may also include or be in communication with one or more output elements (not shown), such as audio output, video output, screen/display output, motion output, movement output, and/or the like.

As will be appreciated, one or more of the management computing entity's 100 components may be located remotely from other management computing entity 100 components, such as in a distributed system. Furthermore, one or more of the components may be combined and additional components performing functions described herein may be included in the management computing entity 100. Thus, the management computing entity 100 can be adapted to accommodate a variety of needs and circumstances. As will be recognized, these architectures and descriptions are provided for exemplary purposes only and are not limiting to the various embodiments.

### 2. Exemplary Care Team Member Computing Entity

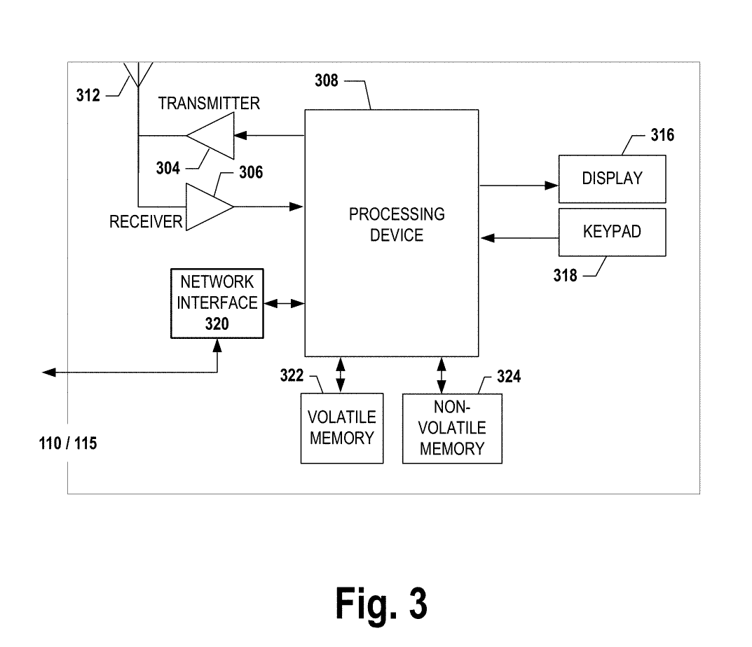

A care team member may be an individual, a group of individuals, a company, an organization, an entity, a department within an organization, a representative of an organization and/or person, and/or the like. Exemplary care team members are discussed in greater detail below. A care team member may operate a care team member computing entity 110 that includes one or more components that are functionally similar to those of the management computing entity 100. FIG. 3 provides an illustrative schematic representative of a care team member computing entity 110 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Care team member computing entities 110 can be operated by various parties. As shown in FIG. 3, the care team member computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the care team member computing entity 110 may be capable of operating with one or more air interface standards, communication protocols, modulation types, and access types. More particularly, the care team member computing entity 110 may operate in accordance with any of a number of wireless communication standards and protocols, such as those described above with regard to the management computing entity 100. In a particular embodiment, the care team member computing entity 110 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, NFC, Bluetooth™, USB, and/or the like. Similarly, the care team member computing entity 110 may operate in accordance with multiple wired communication standards and protocols, such as those described above with regard to the management computing entity 100 via a network interface 320.

Via these communication standards and protocols, the care team member computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The care team member computing entity 110 can also download changes, add-ons, and updates, for instance, to its firmware, software (e.g., including executable instructions, applications, program modules), and operating system.

According to one embodiment, the care team member computing entity 110 may include a location determining aspects, device, module, functionality, and/or similar words used herein interchangeably. For example, the care team member computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information by be determined by triangulating the care team member computing entity's 110 position in connection with a variety of other systems, including cellular towers, Wi-Fi access points, and/or the like. Similarly, the care team member computing entity 110 may include may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, Near Field Communication (NFC) transmitters, and/or the like. These indoor positioning aspects can be used in a variety of settings to determine the location of someone or something to within inches or centimeters.

The care team member computing entity 110 may also comprise a user interface (that can include a display 316 coupled to a processing element 308) and/or a user input interface (coupled to a processing element 308). For example, the user interface may be a care team member application, module, browser, care team member interface, and/or similar words used herein interchangeably executing on and/or accessible via the care team member computing entity 110 to interact with and/or cause display of information from the management computing entity 100, including the care management platform. The care team member input interface can comprise any of a number of devices allowing the care team member computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the care team member computing entity 110 and may include a full set of alphabetic keys or set of keys that may be activated to provide a full set of alphanumeric keys. In addition to providing input, the care team member input interface can be used, for example, to activate or deactivate certain functions, such as screen savers and/or sleep modes.

The care team member computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management computing entities, data, applications, programs, program modules, scripts, source code, object code, byte code, compiled code, interpreted code, machine code, executable instructions, and/or the like to implement the functions of the care team member computing entity 110. As indicated, this may include a care team member application that is resident on the entity or accessible through a browser, module, or other care team member interface for communicating with the care team platform of the management computing entity 100 and/or various other computing entities.

In another embodiment, the care team member computing entity 110 may include one or more components or functionality that are the same or similar to those of the management computing entity 100, as described in greater detail above. As will be recognized, these architectures and descriptions are provided for exemplary purposes only and are not limiting to the various embodiments.

### 3. Exemplary Patient Computing Entity

In one embodiment, a patient may operate a patient computing entity 115 that includes one or more components that are functionally similar to those of the management computing entity 100 and/or the care team member computing entity 110. Although the term patient is used, others terms may be used herein interchangeably, including health plan member, user, and/or the like. For example, in one embodiment, each patient computing entity 115 may include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, the user interface may be a patient application, browser, patient interface, and/or similar words used herein interchangeably executing on and/or accessible via the patient computing entity 115 to interact with and/or cause display of information from the management computing entity 100, including the care management platform. This may also enable the patient computing entity 115 to communicate with various other computing entities, such as care team member computing entities 110, and/or various other computing entities. As will be recognized, these architectures and descriptions are provided for exemplary purposes only and are not limiting to the various embodiments.

### III. Exemplary System Operation

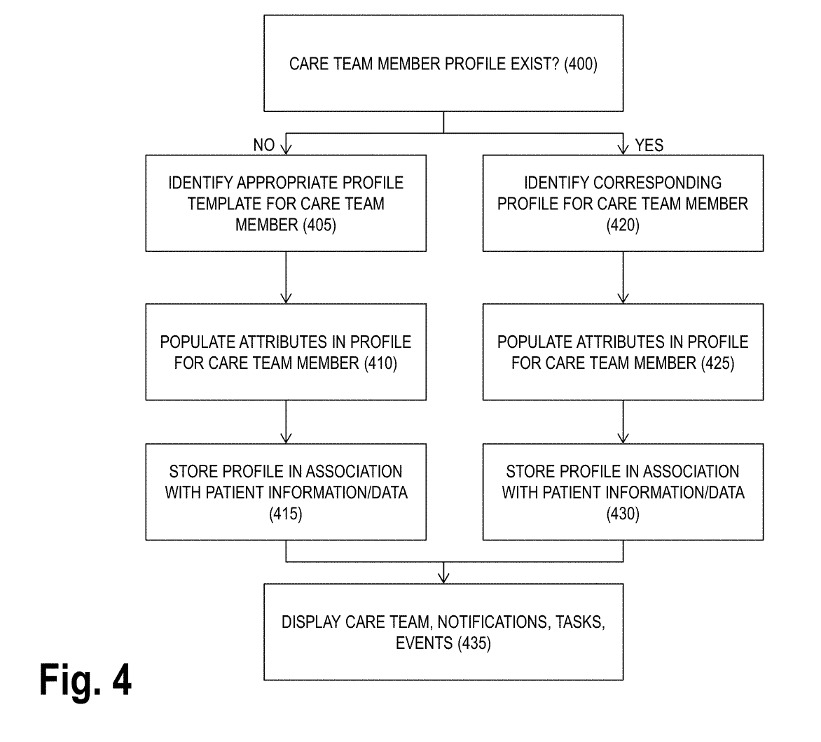

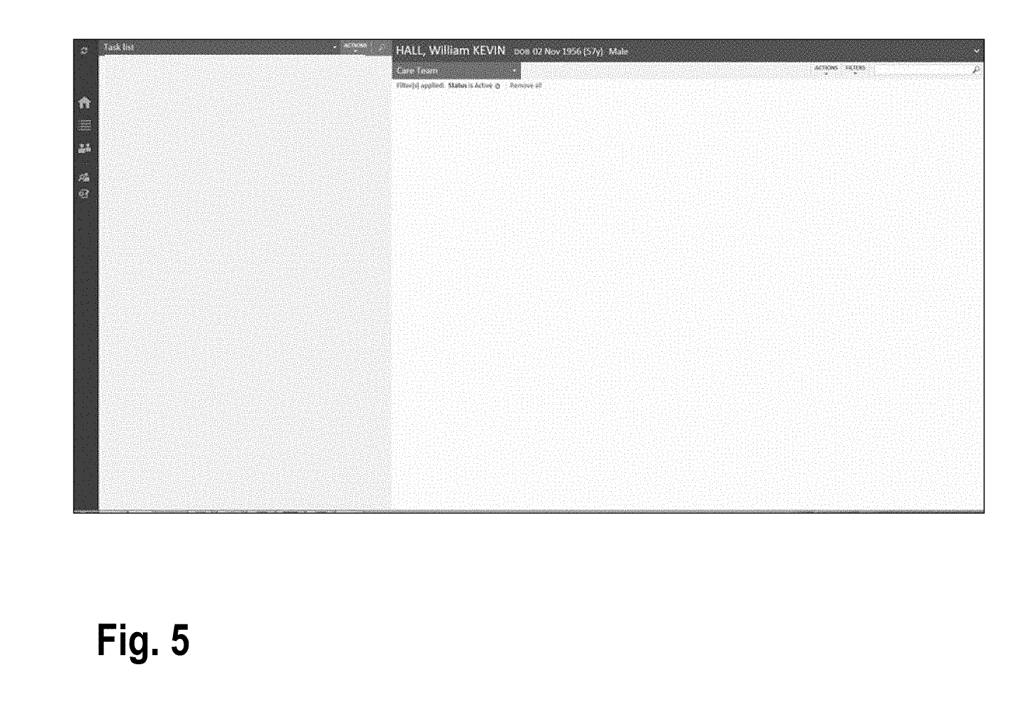

Reference will now be made to FIGS. 4-20. FIG. 4 is a flowchart illustrating operations and processes that may be performed for a care team platform. FIGS. 5-20 are exemplary input and output that can be produced from various embodiments of the present invention.

### 1. Patients and Patient Information/Data

In one embodiment, the management computing entity 100 (executing the care management platform) may store or otherwise have access to patient information/data for patients, which may comprise electronic medical records (EMRs). The patient information/data may comprise a patient's biographic information, such as name, birthdate, age, social security number, addresses, phone numbers, email addresses, and/or the like. The patient information/data may also comprise a patient's weight, height, medical record number, patient or member number, allergies, health issues, medical conditions, and/or the like. The patient information/data may also comprise information/data regarding the patient's surgeries, claims, medical providers, schedules, treatments, care pathways, care programs, medical history, insurance information, payment information, family history, and/or the like. By way of example, FIG. 5 shows a user interface (e.g., a care team member application, module, browser, or interface executing on a care team member computing entity 110 in communication with the care management platform of the management computing entity 100) causing display of patient information/data for a patient named William Kevin Hall. As shown in this FIG. 5, Mr. Hall was born on Nov. 2, 1956, and is male. As will be recognized, a variety of patient information/data can be displayed to adapt to various need and circumstances.

In one embodiment, through the care team member application, browser, module, or care team member interface executing on a care team member computing entity 110, a care team member can create, manage, update, modify, and similar words used herein interchangeably a care team for a patient. The care team can be stored in association with the patient information/data such that a single view simultaneously showing the care team members with their relationships to and responsibilities for the patient can be displayed and accessed.

### 2. Care Teams Members and Profiles Templates

As will be recognized, a care team may comprise one or more care team members. A care team member may be one or more individuals, one or more groups of individuals, one or more companies, one or more organizations, one or more departments or groups within an organization, one or more entities, one or more representatives of an organization and/or a person, and/or the like who play a role in the health care of a patient. As will be recognized, the various roles, degrees of contact with a patient, and access to patient information/data may vary. For example, in one embodiment, each care team may include a lead care team member. Moreover, once a lead care team member is assigned to a patient, to avoid the patient being “lost,” “forgotten,” or “left behind” when the lead care team member is changed, the management computing entity 100 can require a positive handoff to another lead care member. The lead care team member may generally be responsible for guiding the care of a patient and being one of the main points of contact for the patient's care for other care team members.

In one embodiment, the management computing entity 100 (executing the care management platform) can be used to create, manage, and update a profile for each member of a care team for a patient. The management computing entity 100 (executing the care management platform) may also store the profiles and/or information/data therefrom in association with the appropriate patients (e.g., patient information/data). To do so, the management computing entity 100 (executing the care management platform) may store profile templates that correspond to specific types, categories, classifications, and similar words used herein interchangeably of profiles for care team members. In one embodiment, a profile template for each of type, category, or classification of care team members may be associated with certain attributes common to all care team members and/or other attributes specific to the type, category, or classification of the care team member. In another embodiment, each of type, category, or classification of care team members may use the same profile template with all attributes common to all care team members. This attribute information can be received as input using radio buttons, drop down boxes, textual input, voice recognition software, and/or a variety of other approaches and techniques. In either case, as will be described in further detail below, various attributes can be removed, modified, and/or added to adapt to various needs and circumstances.

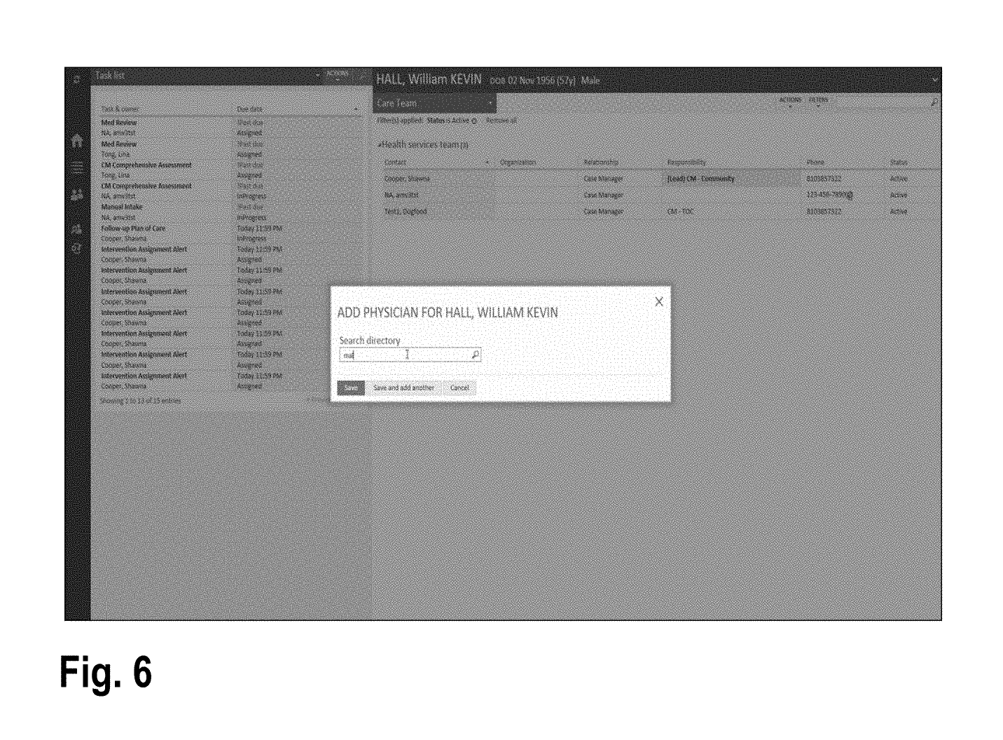

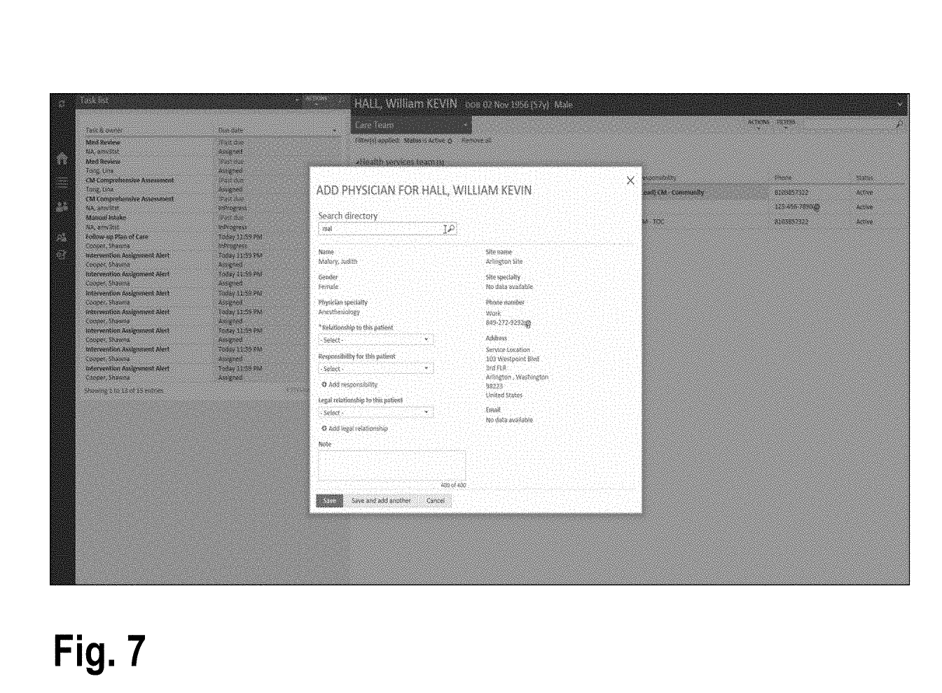

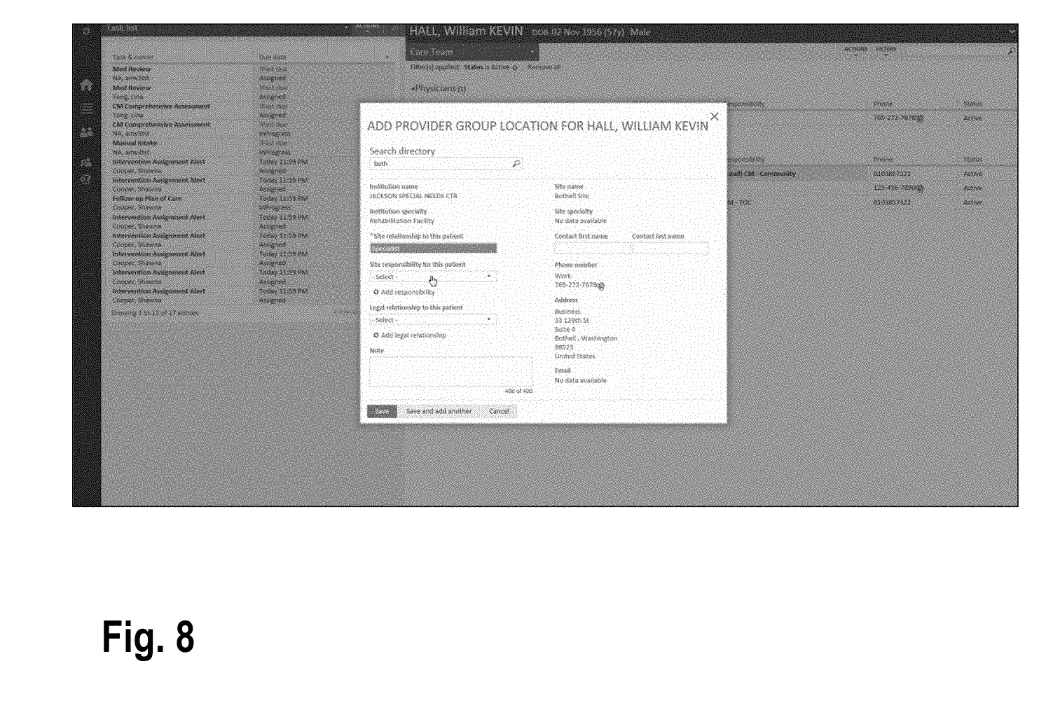

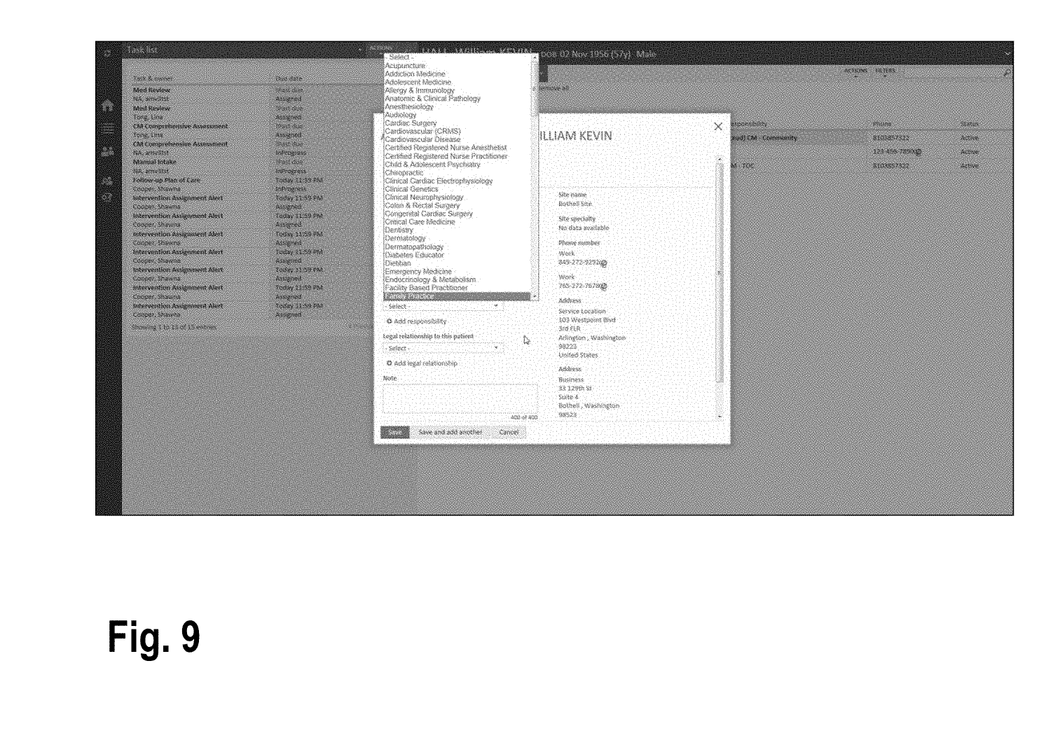

The following types, categories, and classifications of care team members are used for illustrative purposes and are not limiting to embodiments of the present invention. For instance, a care team member may be categorized or classified as a physician care team member, as a health services care team member, as a family or friend care team member, as a vendor or facility care team member, and as a community organization care team member. By way of example, physician care team members may include various types of physicians, such as physicians trained in anesthesiology, cardiology, dermatology, endocrinology, epilepsy, family practice, general practice, gastroenterology, hematology, infertility medicine, neonatology, neurology, oncology, pathology, podiatry, psychiatry, psychology, rheumatology, urology, and/or the like. In one embodiment, the profile template for physician care team members may include attributes (and corresponding global and patient-specific attribute fields) such as name, gender, age, specialty, schools attended, languages spoken, relationship to patient, responsibility for patient (e.g., medication administration, transportation, support, rehabilitation, and/or the like), legal relationship to patient, certifications, notes, site name, site specialty, phone numbers, pager numbers, work schedules, covering physicians, addresses, SMS addresses, email addresses, preferred methods of contact, and/or the like (see FIGS. 6-7). Further, as shown in FIGS. 8 and 9, a physician may also belong to one or more provider groups that can be added for physician care team members.

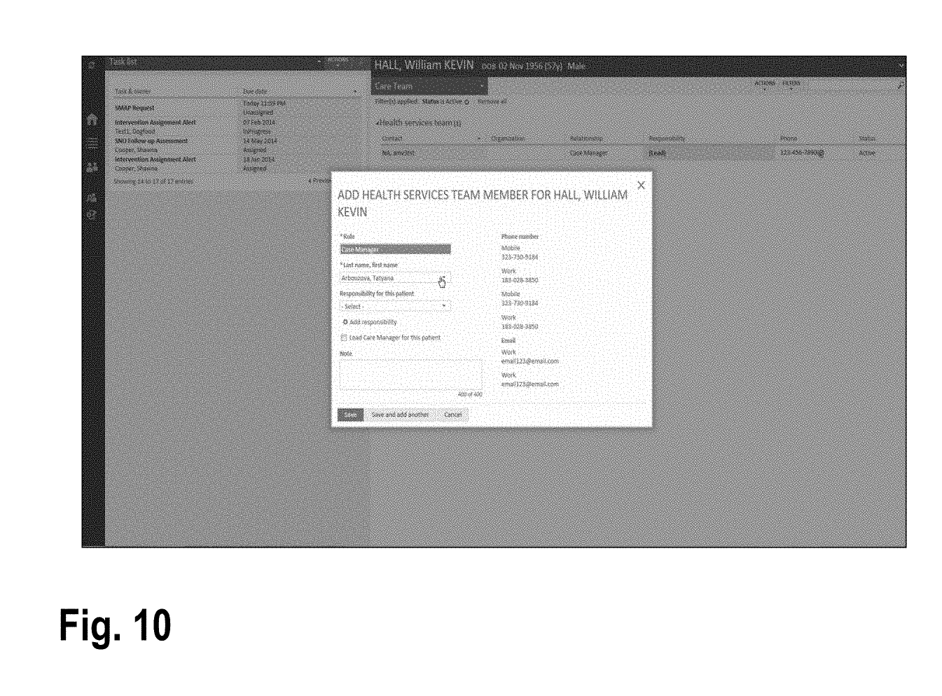

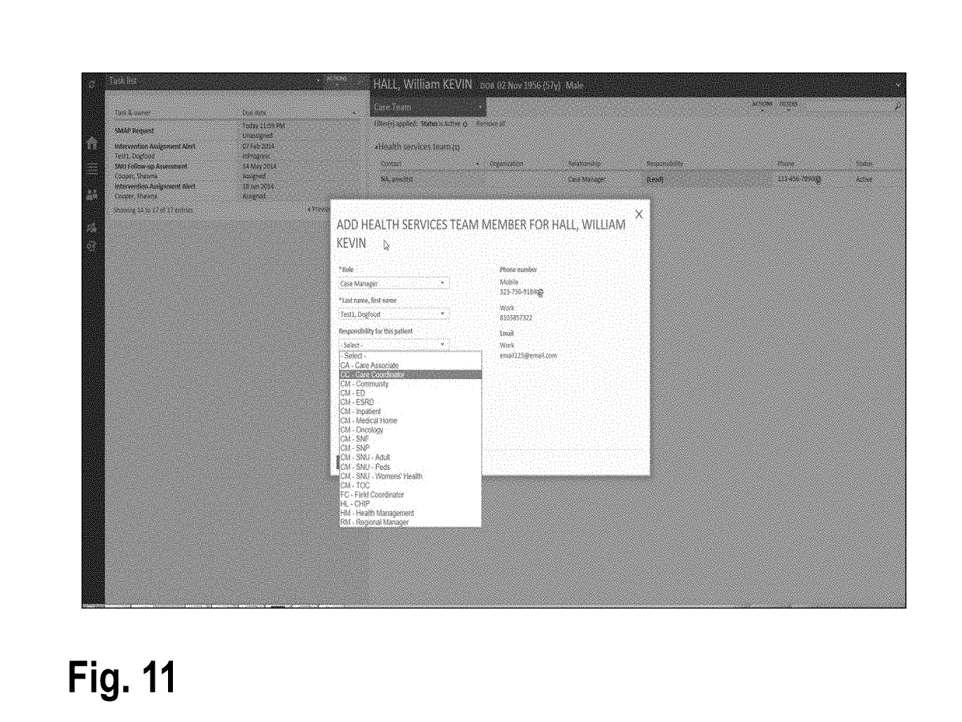

Similar to physician care team members and provider group care team members, health services care team members may include various medical providers or professionals. The medical providers or professionals may include birth attendants, care givers, care managers (include lead care managers), clinicians, dietitians, health coaches, medical assistants, medical technologists, nurses, nurse practitioners, nutritionists, pharmacists, physical therapists, physician assistants, respiratory therapists, speech therapists, case managers, health managers, filed coordinators, social workers, care associates, and/or the like. In one embodiment, the profile template for health services care team members may include attributes (and corresponding global and patient-specific attribute fields) such as name, gender, age, languages spoken, relationship to patient, responsibility for patient, legal relationship to patient, trainings, certifications, notes, site name, site specialty, phone numbers, pager numbers, work schedules, addresses, SMS addresses, email addresses, preferred methods of contact, whether the care team member is the lead care team member, and/or the like (see FIGS. 10 and 11).

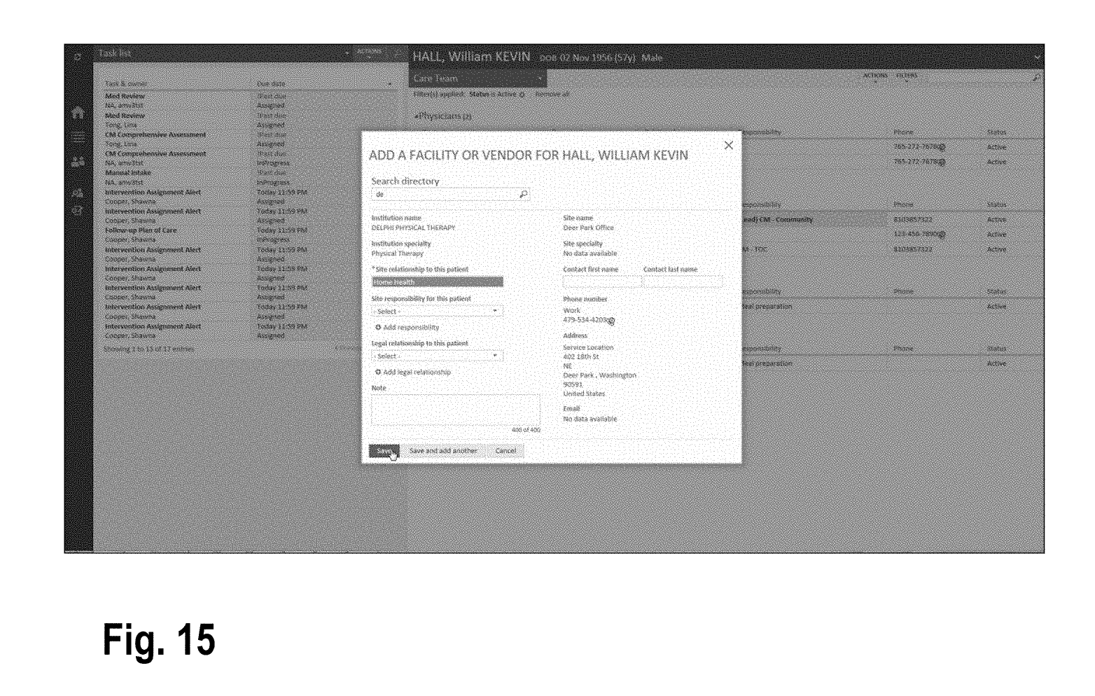

Further, vendors and facilities can be care team members. In one embodiment, vendors and facilities can be clinically-oriented people, entities, organizations, and/or the like. For example, a vendor/facility care team member may be a company from which a patient purchases diabetes supplies, from which a patient obtains supplies for her continuous positive airway pressure (CPAP) machine, to which a patient goes for therapy, and/or the like. In one embodiment, the profile template for vendor/facility care team members may include attributes (and corresponding global and patient-specific attribute fields) such as name, specialty, relationship to patient, responsibility for patient, notes, site name, site specialty, phone numbers, hours of operation, addresses, email addresses, a specific contact at the vendor or facility (including the contact's name, email addresses, phone numbers), and/or the like (see FIG. 15).

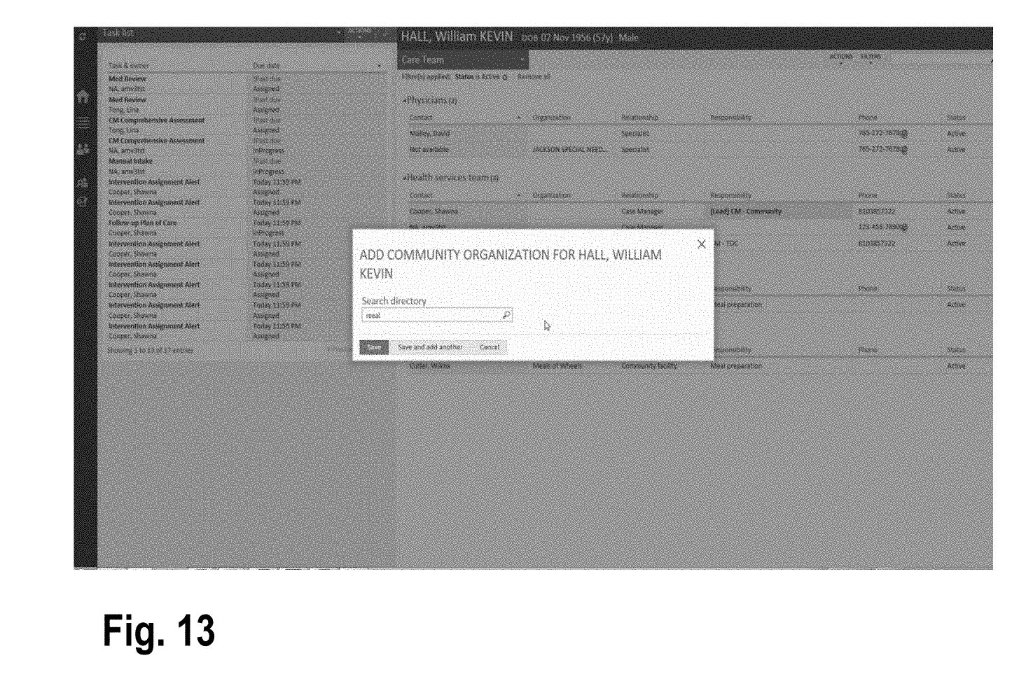

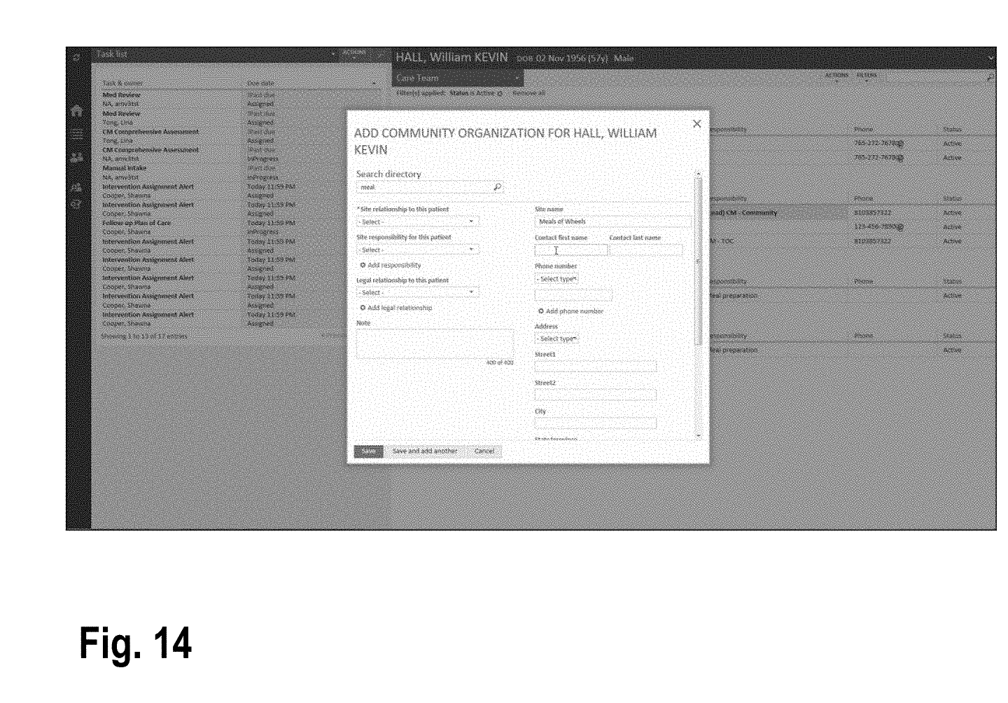

As previously discussed, community organizations and other entities can be care team members. Community organizations and other entities can be non-clinically-oriented people, entities, organizations, and/or the like. The people, entities, organizations, and/or the like may include food service providers (e.g., Meals on Wheels), non-emergency transportation providers, house cleaners, churches, and/or the like. In one embodiment, the profile template for community organizations and other entities may include attributes (and corresponding global and patient-specific attribute fields) such as name, specialty, relationship to patient, responsibility for patient, notes, site name, site specialty, phone numbers, hours of operation, addresses, email addresses, a specific contact at the organization or entity (including the contact's name, email addresses, phone numbers), and/or the like (see FIGS. 13 and 14).

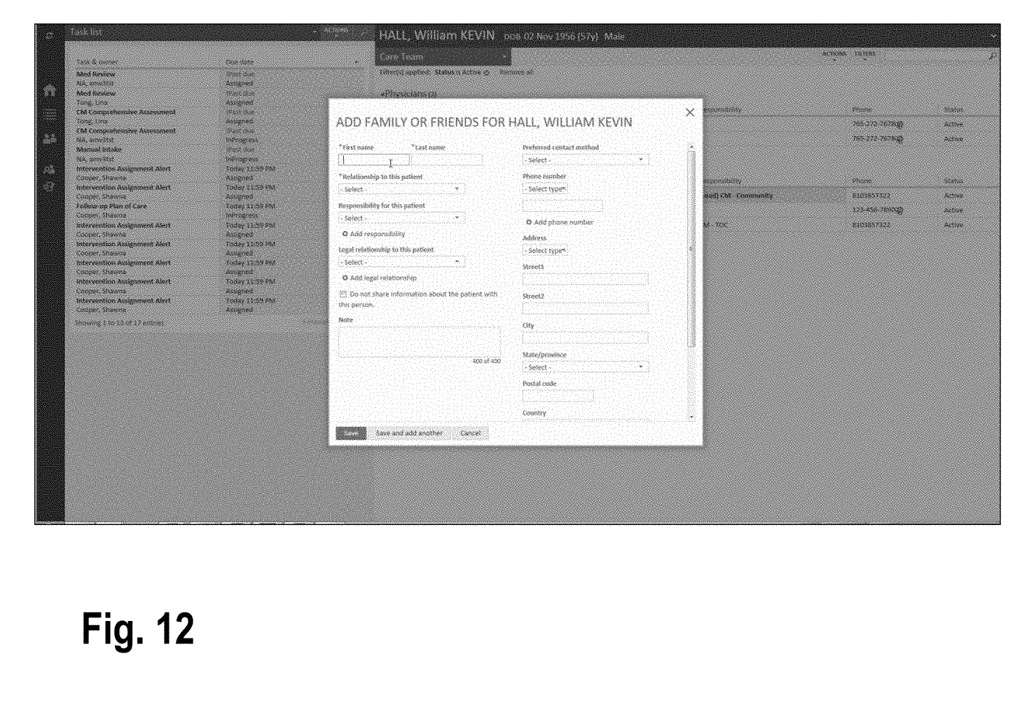

Care team members may also be family members (e.g., biological or legal relatives) or friends of the patient. For example, family members may include grandparents, parents, spouses, uncles, aunts, sons, daughters, nieces, nephews, and/or the like. Similarly, friends may be people the patient considers friends. In one embodiment, the profile template for family or friends care team members may include attributes (and corresponding global and patient-specific attribute fields) such as name, relationship to patient, responsibility for patient, phone numbers, notes, addresses, email addresses, whether information about the patient should be shared with the care team member, and/or the like (see FIG. 12).

As will be discussed in greater detail below, profile templates for care team members can be populated. A populated profile template may include global information/data and patient-specific information/data. The global information/data can used to store the created profile in a directory/database for reuse in other care teams for patients (including the type, category, or classification of the care team member). The global information/data may include attributes, such as name, address, and contact information. However, the patient-specific information/data for the patient might only be accessible for members of the patient's care team. But, as will be recognized, in some instances, other parties may have access to patient-specific information/data even though they are not members of the care team, e.g., pharmacists, managers, claims processors, auditors, physicians to whom the patient has been referred, and/or the like. For example, this may include a care team member's relationship to the patient, legal relationship to the patient, responsibilities for the patient, notes for the patient, and/or the like. As will be recognized, each profile can also be associated with access rights that define or indicate the data to which the care team member has access. For example, community care team members should not be provided with information regarding a patient's medical condition, but health services care team members may be provided with this information.

### 3. Creating and Managing Care Teams

As will be recognized, care teams can be created and managed using a variety of techniques and approaches. The below describes manual, semi-automatic, and automatic approaches for accomplishing the same. However, embodiments of the present invention include combinations of the manual, semi-automatic, and automatic approaches for create and managing care teams.

a. Manual Approach

In one embodiment, a lead care team member (e.g., operating a care team member computing entity 110 in communication with the care team management platform executing on the management computing entity 100) can create, manage, update, and/or modify a care team for a patient using a manual approach. For instance, a lead care team member (e.g., operating a care team member computing entity 110) can select or activate the appropriate function to add a care team member for a patient (e.g., selecting the appropriate action under the Care Team tab or Actions tab in FIG. 5, initiating a request, and/or similar words used herein interchangeably). Although the following description indicates the lead care team member performing various operations, embodiments of the present invention are not so limited. That is, various other care teams members, managers, and/or the like can perform the various operations described herein.

Returning to the above example, a lead care team member (e.g., operating a care team member computing entity 110) can create a care team for William Kevin Hall once the patient information/data for Mr. Hall is being displayed by the care team member computing entity 110. Then, the lead care team member (e.g., operating a care team member computing entity 110) can add the appropriate care team members for Mr. Hall. For instance, the lead care team member (e.g., operating a care team member computing entity 110) can search a directory/database of physicians using known attributes of Mr. Hall's physicians (see. FIG. 6). If a profile has already been created or ingested via a feed (e.g., data sources) for the physician and is being stored by the management computing entity 100 (from a profile template) for the care team member being searched for, the management computing entity 100 (executing the care management platform) can return the results to the lead care team member (Blocks 400 and 420 of FIG. 4). As shown in FIG. 7, Dr. Judith Malory's profile has been identified based on a search of the directory/database using the search term “mal.” The lead care team member (e.g., operating a care team member computing entity 110) can then add Dr. Malory as a care team member on Mr. Hall's care team. In doing so, the lead care team member (e.g., operating a care team member computing entity 110) can input patient-specific information/data to supplement the global information/data already stored by the management computing entity 100 in the directory/database (Block 425 of FIG. 4). The lead care team member (e.g., operating a care team member computing entity 110) can then save the physician's profile as a care team member for Mr. Hall (Block 430 of FIG. 4). This saves the global information/data stored in the profile from the directory/database for Dr. Malory and also the patient-specific information/data input by the lead care team member (e.g., operating a care team member computing entity 110). In this example, the global information/data includes Dr. Malory's name, gender, physician specialty, site name, work number, and address. The patient-specific information/data includes Dr. Malory's relationship to Mr. Hall (e.g., Mr. Hall's specialist), Dr. Malory's responsibility for Mr. Hall, Dr. Malory's legal relationship to Mr. Hall, and/or notes. As shown in FIG. 7, more than one input can be stored for a given attribute. FIGS. 8 and 9 illustrate a provider group of which Dr. Malory is a member. This information/data can also be stored in association with the patient's information/data.

In an example in which a profile had not been created for Dr. Malory and stored by the management computing entity 100 in a directory/database, for instance, the management computing entity 100 can provide the profile template for physician care team members to be populated by the lead care team member (e.g., operating a care team member computing entity 110)—Block 405 of FIG. 4. As previously described, the profile template may include attributes (and corresponding global and patient-specific attribute fields) such as name, gender, age, specialty, schools attended, languages spoken, relationship to patient, responsibility for patient, legal relationship to patient, certifications, notes, site name, site specialty, phone numbers, pager numbers, work schedules, covering physicians, addresses, SMS addresses, email addresses, preferred methods of contact, and/or the like. Once appropriately populated (Block 410 of FIG. 4), the management computing entity 100 can store the global information/data and any patient-specific information data (e.g., the populated profile) in association with the corresponding patient information/data (Block 415 of FIG. 4)—Mr. Hall in this example. The management computing entity 100 (executing the care management platform) can also store the global information/data from the populated profile template as a profile in the directory/database (including the type, category, or classification of the care team member). This will allow others to use the global information/data from the profile for other care teams.

As shown in FIGS. 10 and 11, the lead care team member (e.g., operating a care team member computing entity 110) can also add health services care team members to the care team. To do so, the lead care team member (e.g., operating a care team member computing entity 110) can first identify the role for the care team member to be added. The role may also define or indicate the information/data to which the care team member will have access, the care team views that can be provided to the care team member, and the rights and permissions provided to the care team member via the management computing entity 100. In response, the management computing entity 100 (executing the care management platform) can provide the lead care team member (e.g., operating a care team member computing entity 110) with a list for display of possible care team members who can fulfill identified role (Block 420 of FIG. 4). To do so, the management computing entity 100 can search the directory/database for care team members whose attributes qualify them for the identified role (e.g., filtering profiles based on the attribute). Upon selection of a displayed profile, the lead care team member (e.g., operating a care team member computing entity 110) can input any patient-specific information/data and then save the profile as a care team member for Mr. Hall—saving both the global information/data and the patient specific information/data in association with the patient information/data for Mr. Hall (Blocks 425 and 430 of FIG. 4). If the desired person is not listed as a possible care team member, the lead care team member (e.g., operating a care team member computing entity 110) can access the profile template for health services care team members to create a profile for the desired health services care team member (Block 405 of FIG. 4). As indicated, the profile template for health services care team members may include attributes (and corresponding global and patient-specific attribute fields) such as name, gender, age, languages spoken, relationship to patient, responsibility for patient, legal relationship to patient, certifications, notes, site name, site specialty, phone numbers, pager numbers, work schedules, addresses, SMS addresses, email addresses, preferred methods of contact, whether the care team member is the lead, and/or the like (see FIGS. 10 and 11). Once appropriately populated, the management computing entity 100 can store the global information/data and any patient-specific information data (e.g., the populated profile) in association with the corresponding patient information/data (Blocks 410 and 415 of FIG. 4). The management computing entity 100 (executing the care management platform) can also store the global information/data from the populated profile template as a profile in the directory/database for use by others (including the type, category, or classification of the care team member).

As shown in FIG. 12, the lead care team member (e.g., operating a care team member computing entity 110) can also add family or friends care team members to the care team. As previously described, the lead care team member (e.g., operating a care team member computing entity 110) can access the profile template for family or friends care team members to create a profile for the desired family member or friend (Block 405 of FIG. 4). In one embodiment, the profile template for family or friends care team members may include attributes (and corresponding global and patient-specific attribute fields) such as name, relationship to patient, responsibility for patient, phone numbers, notes, addresses, email addresses, whether information about the patient should be shared with the care team member, and/or the like (see FIGS. 13 and 14). Once appropriately populated, the management computing entity 100 (executing the care management platform) can store the information/data from the populated profile template in association with the corresponding patient information/data (Blocks 410 and 415 of FIG. 4). By way of example, if a spouse is listed as a care team member with the role of medication administration, the lead care team member can remind them about dosages or notify the spouse of medication changes. In this example, information/data from the populated profile template is not stored in the directory/database for use by others for various reasons. For instance, family and friends may not want their information shared or the likelihood of use by other patients is too low to warrant saving the information/data in a directory/database.

As shown in FIGS. 13, 14, and 15, the lead care team member (e.g., operating a care team member computing entity 110) can also add vendor or facility care team members and/or community organization care team members. To do so, the lead care team member (e.g., operating a care team member computing entity 110) can search a directory/database of vendors, facilities, or community organizations to identify a profile of the desired care team member (Blocks 400 and 420 of FIG. 4). In response (see FIG. 13), the management computing entity 100 (executing the care management platform) can return the results for display to the lead care team member (e.g., operating a care team member computing entity 110). If a profile exists in the directory/database, the lead care team member (e.g., operating a care team member computing entity 110) can then add the care team member to the care team. In doing so, the lead care team member (e.g., operating a care team member computing entity 110) can input patient-specific information/data to supplement the global information/data provided by the management computing entity 100 (Blocks 425 and 430 of FIG. 4). As previously described, the management computing entity 100 can store the global information/data and any patient-specific information data (e.g., the populated profile) in association with the corresponding patient information/data. If a profile is not identified based on the search, the management computing entity 100 can provide the profile template for vendor and facility team members and/or community organization team members to be populated by the lead care team member (e.g., operating a care team member computing entity 110)—Block 405 of FIG. 4. Once appropriately populated, the management computing entity 100 can store the global information/data and any patient-specific information data (e.g., the populated profile) in association with the corresponding patient information/data (Blocks 410 and 415 of FIG. 4). The management computing entity 100 (executing the care management platform) can also store the global information/data from the populated profile template as a profile in the directory/database for use by others (including the type, category, or classification of the care team member). As will be recognized, a variety of other approaches and techniques can be used to adapt to various needs and circumstances.

b. Semi-Automated or Automated Approach

In one embodiment, the management computing entity 100 (executing the care management platform) can create, manage, update, and/or modify a care team for a patient using semi-automated or automated approaches. In one embodiment, the process may begin with one or more data source computing entities (not shown) providing health-related data to the management computing entity 100 (executing the care management platform). The health-related data can be provided to and received by the management computing entity 100 (executing the care management platform) on a routine basis, periodic basis, and/or continuously (e.g., via a data feed). The health-related data may include patient information/data, claims data, external data, and/or various other types of data.

Various non-limiting examples of patient information/data have been previously described. Claims data may include information about one or more claims corresponding to a patient. A claim may be a request for payment/reimbursement for services rendered, materials used, medication provided or dispensed, equipment provided, and/or the like in connection with treating, monitoring, evaluating, and/or diagnosing an injury, illness, condition, and/or concern. For example, a claim may be a request for payment/reimbursement for a consultation with a medical provider, a medical procedure or an evaluation performed by an orthopedic surgeon, a laboratory test performed by a laboratory, durable medical equipment provided to an injured patient, medications or other materials used in the treatment of a patient, and/or the like.

In one embodiment, after receiving health-related data, the management computing entity 100 (executing the care management platform) can access, process, analyze, and/or apply one or more rules and/or one or more sets of rules (e.g., via a rules engine) to the health-related data to identify potential care team members for patients. For example, if a claim for an office visit to Dr. Walter Smith has been processed and paid for Mr. Hall, the management computing entity 100 (executing the care management platform) can identify Dr. Smith as a potential care team member for Mr. Hall. If Dr. Smith is not a care team member for Mr. Hall, the management computing entity 100 (executing the care management platform) can then generate a notification to add Dr. Smith to Mr. Hall's care team (subject to approval or rejection by the lead care team member). Thus, in analyzing the health-related data, the management computing entity 100 (executing the care management platform) identifies the patient and the potential care team member and determines whether the potential care team member is currently a member of the patient's care team. If the potential care team member is not currently a member of the patient's care team, the management computing entity 100 (executing the care management platform) can generate a notification to the lead care team member (e.g., operating a care team member computing entity 110) that a possible new care team member has been identified. In this example, the notification can indicate that Dr. Smith has been identified as a possible care team member for Mr. Hall. In some embodiments, the decision and steps taken for adding Dr. Smith as a care team member can be left up to the lead care team member as described above with regard to the manual approach (Blocks 400, 405, 410, 415, 420, 425, and 430 of FIG. 4). In other embodiments, the decisions are not necessarily left up to the lead care team member. For example, a primary care provider identified in the health-related data might not be removable from a patient's care team. In other words, integrity constraints can be imposed upon care team members to ensure the accuracy of the care team.

In a more automated approached, the management computing entity 100 (executing the care management platform) can automatically add potential care team members if the management computing entity 100 (executing the care management platform) determines that the potential care team member is currently a member of the patient's care team. In this embodiment, the management computing entity 100 (executing the care management platform) identifies the patient and the potential care team member and determines whether the potential care team member is currently a member of the patient's care team. If the potential care team member is not currently a member of the patient's care team, the management computing entity 100 (executing the care management platform) can automatically add the care team member from an existing profile in a directory/database (Blocks 420, 425, and 430 of FIG. 4). This automatic addition may be subject to further approval, rejection, and/or review by the lead care team member (e.g., operating a care team member computing entity 110). The management computing entity 100 can also generate a notification to the lead care team member (e.g., operating a care team member computing entity 110) indicating that a new care team member has been added for Mr. Hall. This can provide the lead care team member (e.g., operating a care team member computing entity 110) with the ability to input patient-specific information and/or approve, reject, and/or review the added care team member.

In one embodiment, the management computing entity 100 can provide a snapshot or view of care teams at different points in time. For example, a care team for Mr. Hall on Feb. 5, 2014, might have two care team members that can be displayed via an appropriate computing entity. Then, the care team for Mr. Hall might have five care team members on May 8, 2014, that can be displayed via an appropriate computing entity. Thus, the management computing entity 100 can store “snapshots” of the care team as it changes over time. This may be a useful tool to aid in understanding who has been involved (and their relationships and other details) in delivering a patient's health care. As will be recognized, a variety of techniques and approaches can be used to adapt to various needs and circumstances.

### 4. Display and Monitoring of Care Team Members

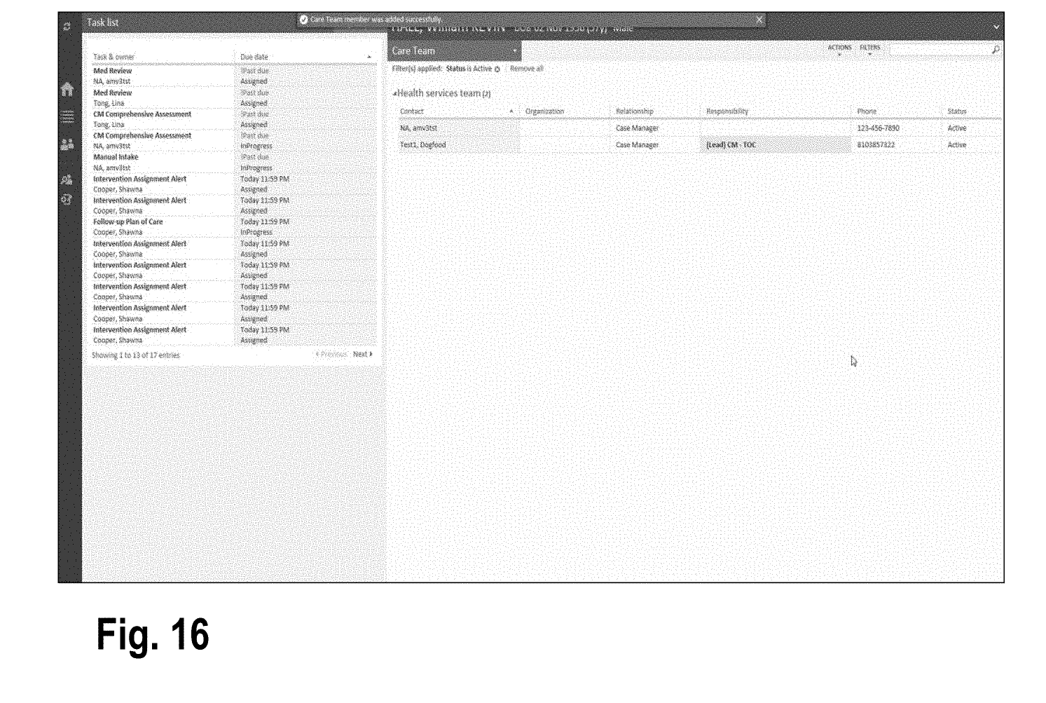

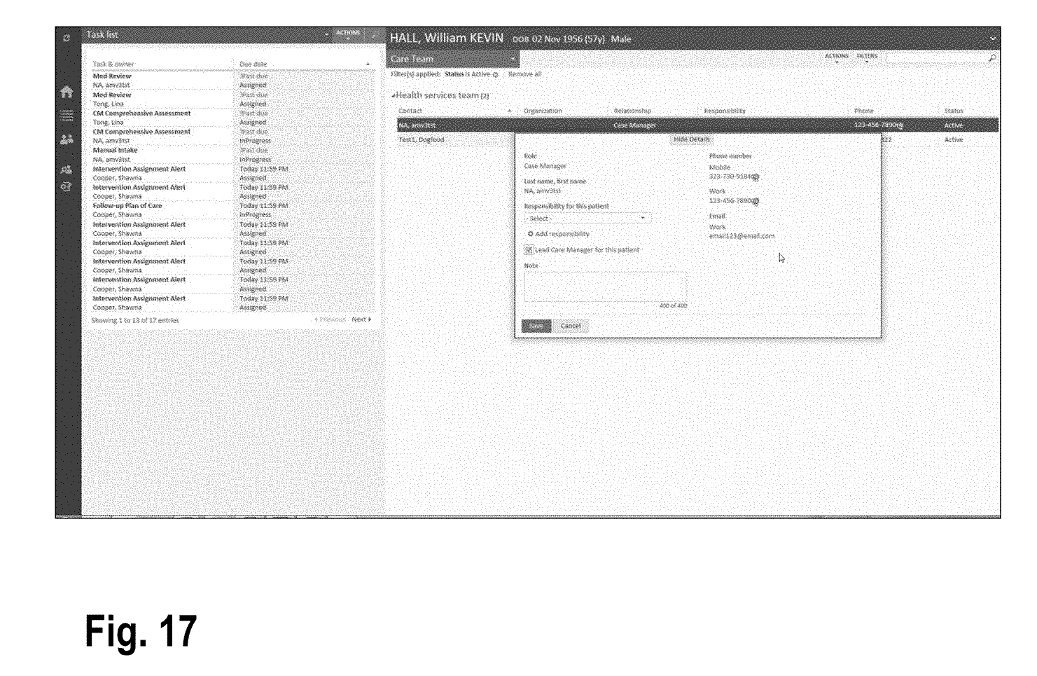

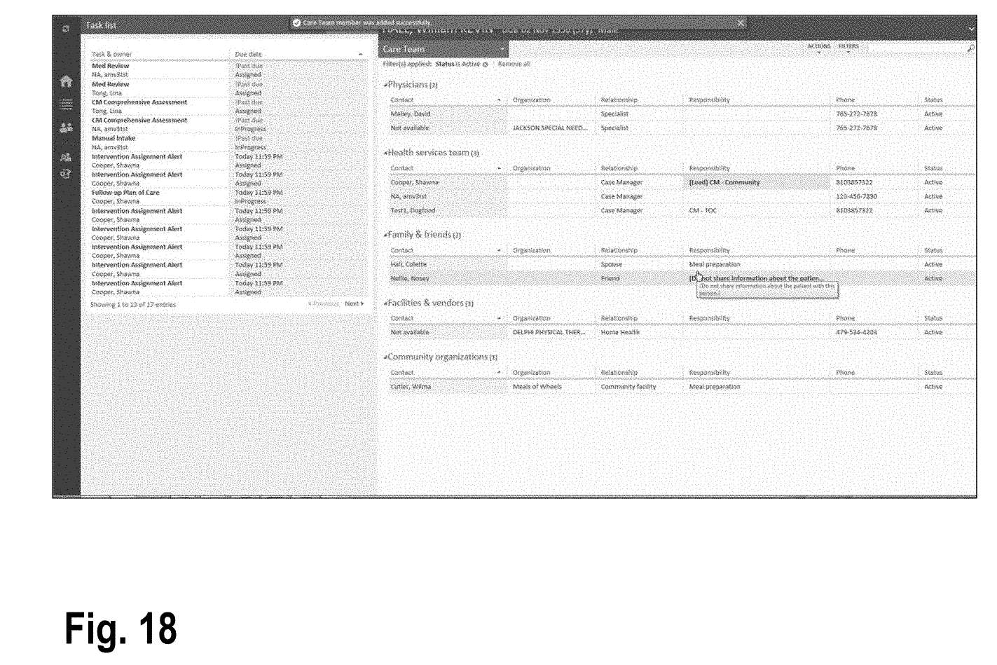

As shown in FIGS. 16-20, the management computing entity 100 (executing the care management platform) can cause display of or otherwise provide information associated with a care team to members of the care team (Block 435 of FIG. 4). For example, FIG. 16 simultaneously shows a single view of health services care team members for Mr. Hall. In this example, only two care team members are displayed which may indicate that the care team only comprises two members or it may indicate that a filter is set to only show health services care team members. As shown in FIG. 17, a care team member (e.g., care team member computing entity 110) can hover over, select, or otherwise activate a function to cause more-detailed information/data to be displayed for a care team member. In the example of FIG. 17, responsive to such an activation, an appropriate computing entity can cause display of a pop-up window or dialog box with this information. FIG. 18 simultaneously shows a single view of the various care team members (e.g., displayed via a care team member computing entity 110). In the single view of FIG. 18, the plurality of care team members are displayed with their relationships to and responsibilities for the patient and contact information for contacting the same—with no filter being applied. This single, simultaneous view provides care team members with an understanding of the entire care team along with the respective roles, relationships, responsibilities, and rights. For certain care team members, this may require pulling/accessing global information/data from the directory and patient-specific information/data stored in association with the patient's information/data. For instance, a pointer (e.g., a care team member's ID) to the global information/data may be stored in association with the patient's information/data that maps to a table with the global information/data about the care team member. The patient-specific information/data can be pulled/accessed from the patient information/data. The single view may then combine both types of data which will reflect the most up-to-date information/data for the care team member.

In one embodiment, the management computing entity 100 can also provide different views of the care team for the different care team members based on the respective roles. For example, the lead care team member may be provided with access or views of all care team members, while others may only be provided with access or views of limited information such as care team member relationships. The management computing entity 100 can also cause display of different care team views, including a patient view and a care team view. For instance, the patient view may cause display of all care team members on a patient's care team. The care team view may cause display of all patients for whom a care team member is on a care team. As will be recognized, a variety of other approaches and techniques can be used to adapt to various needs and circumstances.

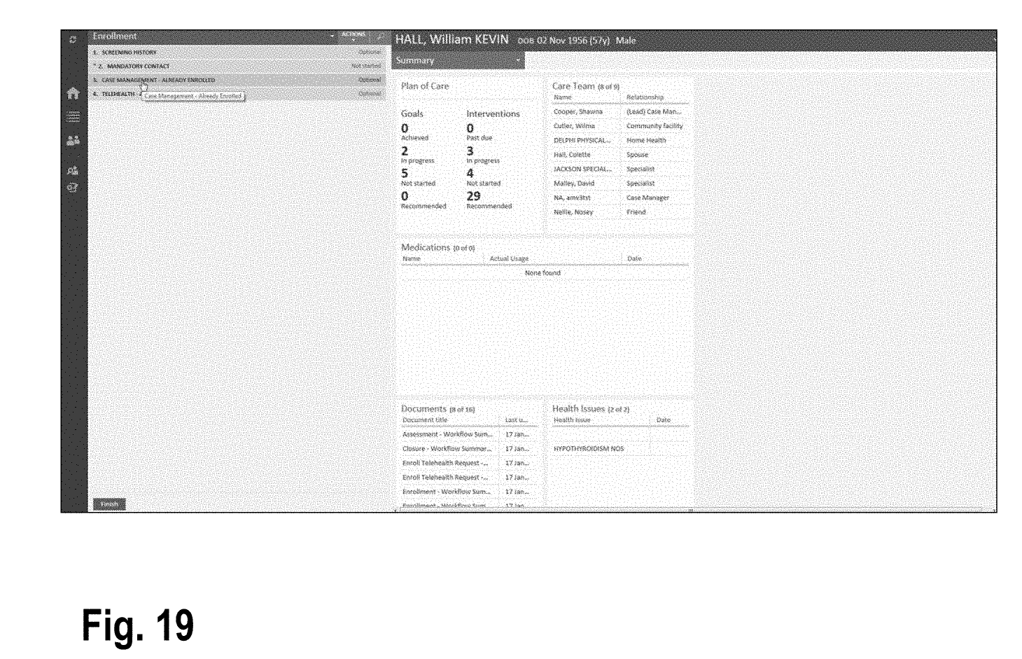

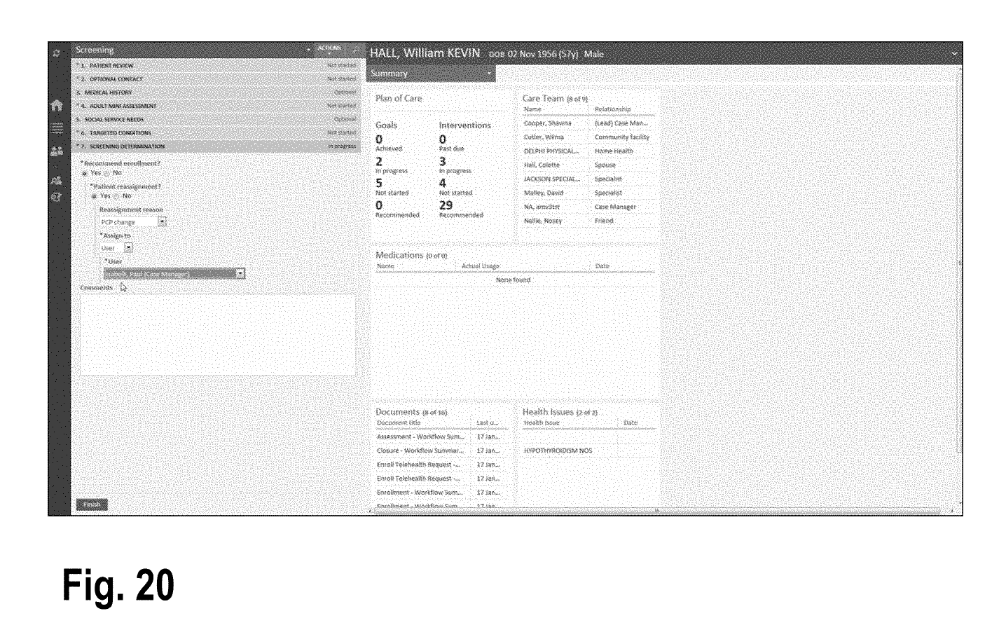

FIGS. 19 and 20 show different views provided by the management computing entity 100 (executing the care management platform) to show various actions, tasks, and/or notifications related to the patient and/or care team members. For example, the management computing entity 100 (executing the care management platform) can identify changes, additions, updates, and/or removals in or to the health-related data. Such changes, additions, updates, and/or removals may indicate that one or more events have occurred related to a patient. For example, the changes, additions, updates, and/or removals may indicate that a patient has been admitted to a hospital or that a patient has been involved in a motor vehicle accident. These changes, additions, updates, and/or removals may be used by the management computing entity 100 (executing the care management platform) to provide notifications to care team members via the care team member interface so that the care team members can respond to the same. For instance, the lead care team member may call the hospital to which the patient was admitted to explain medications the patient is taking or call the patient's friends and family based on the composition of the care team. The care team member interface can also provide notifications of care team members that can be or have been added to a patient's care team. As will be recognized, a variety of techniques and approaches can be used to adapt to various needs and circumstances.

In one embodiment, the management computing entity 100 (executing the care management platform) provides the ability to assign tasks to care team members via notifications using various rules and/or sets of rules. For example, the management computing entity 100 (executing the care management platform) can send emails, or texts, and/or provide tasks/notifications via an interface to a patient's specialist containing the patient's most recent plan of care and medication review snapshots. Similarly, the management computing entity 100 (executing the care management platform) can access and cause display of tasks/notifications associated with a patient's care pathways. In this example, when the lead care team member accesses the care team interface (e.g., operating a care team member computing entity 110), the lead care team member can follow up as necessary based on the tasks/notifications displayed via the care team interface. The follow up may be with other care team members (reminding a patient's spouse to administer medication) or patients (reminding a patient to not smoke or to walk 20 minutes during the day). Similarly, the tasks and notifications can flow back and forth between care team members (e.g., operating a care team member computing entity 110) and patients (e.g., operating a patient computing entity 115). The care management platform provides an integrated solution through which tribal knowledge associated with patients and care teams members can be stored, accessed, saved, and shared for the benefit of the patient and other care team members. For example, the notes for each care team member can be stored in association with patient information/data to maintain and share any tribal knowledge. If, for instance, the patient changes physicians or health plans, moves to a new area, and/or the like, the tribal knowledge for the patient can be shared with the new care team members. As will be recognized, a variety of other approaches and techniques can be used to adapt to various needs and circumstances.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for managing a care team, the method comprising:
storing, via one or more processors, a plurality of care team member profiles in association with patient information for a patient, each care team member profile identifying the respective care team member's (i) role for and (ii) relationship with the patient, each care team member profile categorized and comprising global information and patient-specific information; and
causing, via the one or more processors, simultaneous display of at least a portion of each of the plurality of care team member profiles including the global information and patient-specific information, the displayed plurality of care team member profiles is categorized.

2. The method of claim 1, wherein the patient-specific information includes relationship with the patient.

3. The method of claim 2, wherein the global information of the at least one of the plurality of care team member profiles is stored in a directory for use in other care teams.

4. (canceled)

5. The method of claim 1 further comprising causing display of tasks associated with the care team.

6. The method of claim 1, wherein at least one of the plurality of care team member profiles is identified based at least in part on user input.

7. The method of claim 1, wherein at least one of the plurality of care team member profiles is identified based at least in part on applying one or more rules to health-related data.

8. The method of claim 1, wherein each care team member's role defines the access rights of the care team member.

9. An apparatus comprising at least one processor and at least one memory including program code, the at least one memory and the program code configured to, with the processor, cause the apparatus to at least:
store a plurality of care team member profiles in association with patient information for a patient, each care team member profile identifying the respective care team member's (i) role for and (ii) relationship with the patient, each care team member profile categorized and comprising global information and patient-specific information; and
cause simultaneous display of at least a portion of each of the plurality of care team member profiles including the global information and patient-specific information, the displayed plurality of care team member profiles is categorized.

10. The apparatus of claim 9, wherein the patient-specific information includes relationship with the patient.

11. The apparatus of claim 10, wherein the global information of the at least one of the plurality of care team member profiles is stored in a directory for use in other care teams.

12. (canceled)

13. The apparatus of claim 9, wherein the memory and program code are further configured to, with the processor, cause the apparatus to cause display of tasks associated with the care team.

14. The apparatus of claim 9, wherein at least one of the plurality of care team member profiles is identified based at least in part on user input.

15. The apparatus of claim 9, wherein at least one of the plurality of care team member profiles is identified based at least in part on applying one or more rules to health-related data.

16. The apparatus of claim 9, wherein each care team member's role defines the access rights of the care team member.

17. A computer program product for managing a care team, the computer program product comprising at least one non-transitory computer-readable storage medium having computer-readable program code portions stored therein, the computer-readable program code portions comprising:
an executable portion configured to store a plurality of care team member profiles in association with patient information for a patient, each care team member profile identifying the respective care team member's (i) role for and (ii) relationship with the patient, each care team member profile categorized and comprising global information and patient-specific information; and
an executable portion configured to cause simultaneous display of at least a portion of each of the plurality of care team member profiles including the global information and patient-specific information, the displayed plurality of care team member profiles is categorized.

18. The computer program product of claim 17, wherein the patient-specific information includes relationship with the patient.

19. The computer program product of claim 18, wherein the global information of the at least one of the plurality of care team member profiles is stored in a directory for use in other care teams.

20. (canceled)

21. The computer program product of claim 17 further comprising an executable portion configured to cause display of tasks associated with the care team.

22. The computer program product of claim 17, wherein at least one of the plurality of care team member profiles is identified based at least in part on user input.

23. The computer program product of claim 17, wherein at least one of the plurality of care team member profiles is identified based at least in part on applying one or more rules to health-related data.

24. The computer program product of claim 17, wherein each care team member's role defines the access rights of the care team member.
